(19) United States
(12) Patent Application Publication
(10) Pub. No.: US 2009/0326980 A1
(43) Pub. Date: Dec. 31, 2009

(54) FLAGGING TO CONTROL ACCESS TO HEALTH INFORMATION

(75) Inventors: Sean P. Nolan, Bellevue, WA (US); Cezary Marcjan, Redmond, WA (US); Johnson T. Apacible, Mercer Island, WA (US); Michael Gordon, Redmond, WA (US); Jeffrey Jones, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,555

(22) Filed: Jun. 27, 2008

(51) Int. Cl. G06Q 50/00

(52) U.S. Cl. 705/3; 707/9

(57) ABSTRACT

A method for protecting access to health information. The method includes presenting a graphical user interface for accessing health information. The health information may include a health record which includes at least one item. A request to access the health record is received and the health record is retrieved from a data store. The items of the health record are filtered based on a source of the request to access the health record. A portion of the health record may be displayed.

### BACKGROUND

The widespread use and rapid development of the computer technology has allowed exchanging and sharing of information easier than previously possible. The ability to easily share information has become particularly important for sensitive and private information such as health information.

Correspondingly, the ability to selectively control access to health information has become particularly important as a user may wish to control access to sensitive and private health information. For example, a patient may wish to share information about a sport injury but not a mental condition. Conventional solutions have allowed users to grant access to either all or none of the health information. Unfortunately, this means in order for a user to share any information, he/she must share all the health information including private information that he/she might not wish to share.

Thus, what is needed is a way to provide selective access to sensitive health information so that users can choose which information to share.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, protecting access to health information. It involves various techniques for displaying health information and setting a personal flag associated with each health record, item, or file. The personal flag allows users with appropriate privileges to view health information and manage access to the health information. The personal flag may also override rules or other system settings to allow users to restrict access to health information. Therefore, the technology allows users to selectively control access to health information in a granular manner.

In one implementation, a method for protecting access to health information may be used to access health information. A graphical user interface may be presented for accessing the health information from which a request may be received. In response to the request, a health record may be retrieved from the data store. The items of the health record may then be filtered according to the source of the request. The source of the request may be a user with custodian access, view and edit access, or read-only access. A portion of the health record may then be displayed based on the filtering. Thus, access to health information may be protected and accessed in a granular manner.

Techniques described herein provide a way for protecting access to health information. Thus, users are able easily restrict access to health information in a manner or level of his or her choosing.

### BRIEF DESCRIPTION OF THE DRAWINGS

The accompanying drawings, which are incorporated in and form a part of this specification, illustrate embodiments and, together with the description, serve to explain their principles:

FIG. 1 is a block diagram of an exemplary system for accessing health information, in accordance with an embodiment.

FIG. 2 is a block diagram of an exemplary graphical user interface for displaying health information, in accordance with an embodiment.

FIG. 3 is a flowchart of an exemplary process for protecting access to health information, in accordance with an embodiment.

FIG. 4 is a block diagram of an exemplary graphical user interface for configuring access to health information, in accordance with an embodiment.

FIG. 5 is a flowchart of an exemplary process for configuring access to health information, in accordance with an embodiment.

FIG. 6 is a block diagram of an exemplary computing system environment for implementing an embodiment.

### DETAILED DESCRIPTION

Reference will now be made in detail to the embodiments of the claimed subject matter, examples of which are illustrated in the accompanying drawings.

While the invention will be described in conjunction with the embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present invention, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail so as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Overview

Described herein is technology for, among other things, protecting access to health information. It involves various techniques for displaying health information and setting a personal flag associated with each health record, item, or file. The personal flag allows users with appropriate privileges to view health information and manage access to the health information. The personal flag may also override rules or other system settings to allow users to restrict access to health information. Therefore, the technology allows users to selectively control access to health information in a granular manner.

In one implementation, a method for protecting access to health information may be used to access health information. A graphical user interface may be presented for accessing the health information from which a request may be received. In response to the request, a health record may be retrieved from the data store. The items of the health record may then be filtered according to the source of the request. The source of the request may be a user with custodian access, view and edit access, or read-only access. A portion of the health record may then be displayed based on the filtering. Thus, access to health information may be protected and accessed in a granular manner.

Techniques described herein provide a way for protecting access to health information. Thus, users are able easily restrict access to health information in a manner or level of his or her choosing.

### Example System

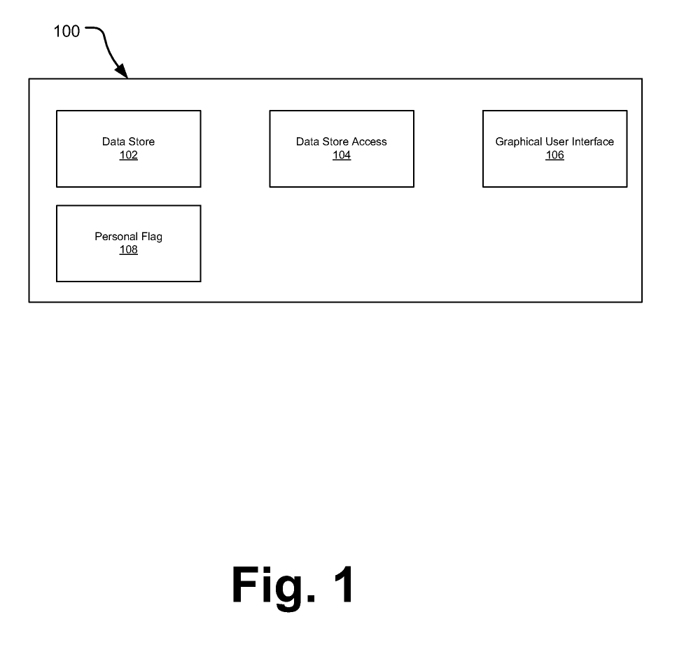

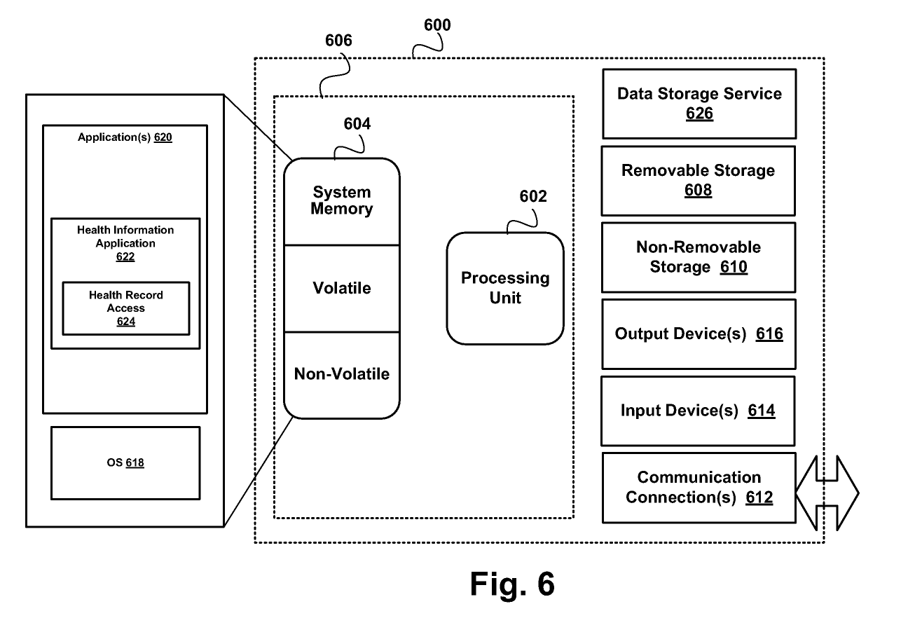

The following discussion sets forth details of the present technology systems for network communication management. FIG. 1 illustrates example components used by various embodiments of the present technology. System 100 includes components or modules that, in various embodiments, are carried out by a processor under the control of computer-readable and computer-executable instructions. The computer-readable and computer-executable instructions reside, for example, in data storage features such as computer usable memory 604, removable storage 608, and/or non-removable storage 610 of FIG. 6. The computer-readable and computer-executable instructions are used to control or operate in conjunction with, for example, processing unit 602 of FIG. 6. It should be appreciated that the aforementioned components of system 100 can be implemented in hardware or software or in a combination of both. Although specific components are disclosed in system 100 such components are examples. That is, embodiments are well suited to having various other components or variations of the components recited in system 100. It is appreciated that the components in system 100 may operate with other components than those presented, and that not all of the components of system 100 may be required to achieve the goals of system 100.

FIG. 1 is a block diagram of an exemplary system 100 for accessing health information, in accordance with an embodiment. System 100 includes data store 102, data store access module 104, graphical user interface module 106, and personal flag module 108.

Data store 102 may store health information. The health information may include one or more health records each including one or more items. Health information can include medical records, injuries, conditions, diseases, medications, medical history, family history, etc. For example, a medication health record may include multiple items each corresponding to particular medications that a patient is currently taking. Data store 102 may be a variety of information storage systems including, but not limited to, a database, knowledge base, or any other system operable to store information for retrieval. In one embodiment, a health record may include information stored in multiple rows of a database and each health record item may correspond to a row in the database.

Data store 102 may further include a personal flag field corresponding to each item in a health record. It is appreciated that the personal flag may be implemented in a variety of ways, including but not limited to, a binary flag or Boolean value. The personal flag field may be used to selectively restrict access to one or more health items within a health record or for the health record itself. A custodian could be owner of the account, patient, user, executor, or any person with agent authority. In one embodiment, only non personal items are retrieved if the user is not a custodian. For example, a health record may contain mental health data including medication which can be marked as personal. If a relative was a non-custodian granted access to a patient's medications the personal flag will ensure that the mental health medication are hidden or not displayed to the relative.

Data store access module 104 facilitates the retrieving health information from data store 102. In one embodiment, data store access module 104 may access data store 102 via an SQL (Structured Query Language) query. In retrieving health information from data store 102, data access module 104 may take into account access rules and the personal flag field. The access rules may be health information system wide rules or specific defined user rules which govern the access to health information. For example, access rules may default to having information about a patient's mental health restricted. The personal flag field may be used to override access rules. Continuing the previous example, a patient may wish to make portion of his or her mental health information available and may do so by setting the personal flag accordingly. Together the access rules and the personal flag, allow data store access module 104 to return only selected health record items and thus a portion of the health record a user wishes to share. The personal flag may further optionally override future access rule changes. For example, the personal flag may protect items as access is granted to new users such that items marked personal will remain personal irrespective of changes to access or authorization rules applied to the health record. The personal flag may thus make it easier for a user to manage personal information.

Graphical user interface module 106 facilitates display of health information stored within data store 102 and accessed via data store access module 104. For example, graphical user interface module 106 may facilitate a user navigating, viewing, and editing health information within data store 102.

Personal flag module 108 facilitates the setting the personal flag associated with each item or file within each health record in data store. In conjunction with graphical user interface module 106, personal flag module 108 may set the personal flag for a health record, health record item, or file based on input received via a graphical user interface facilitated by graphical user interface module 106.

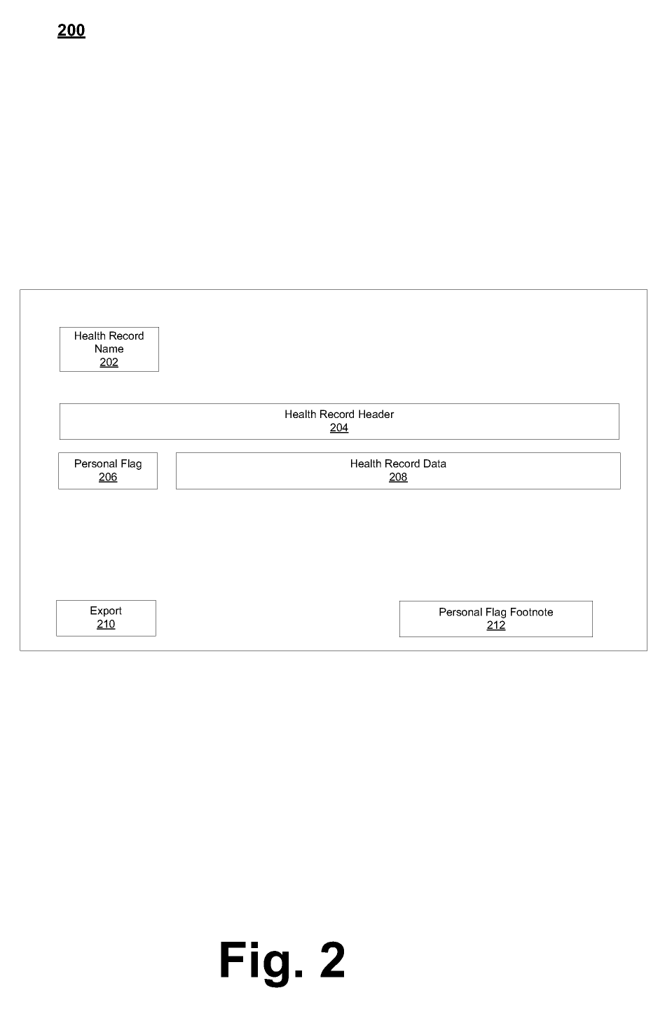

FIG. 2 shows an exemplary graphical user interface 200 for displaying health information, in accordance with an embodiment. Graphical user interface 200 may include health record name 202, health record header 204, personal flag indicator 206, health record data 208, export 210, and personal flag footnote 212. Export control 210 allows a user to invoke an export process to export health information.

Health record name 202 indicates the category or type of health record or file being displayed by graphical user interface 200. For example, health record name 202 may indicate that the cardiac profile for a patient is being displayed.

Health record header 204 display headers for the columns of data contained within the health record. For example, health record header 204 may display column headers associated with hypertension and family cardiac history.

Personal flag indicator 206 indicates whether an item has been marked as personal. In one embodiment, only users with custodian privileges are able to view records, items, and files flagged as personal data.

Health record data 208 displays information corresponding to each item within the health record. For example, health record data 208 may display data specific to a patient's hypertension and family cardiac history.

Personal flag footnote 212 indicates to a user that personal data is being displayed. For example, personal flag footnote 212 may display text including “Personal data is visible only to custodians of this record. Learn more.” where the learn more text is a hyperlink to a help page explaining the personal flag.

It is appreciated that users not having custodian privileges may have rows containing personal flag indicator 206, personal health record data 208, and personal flag footnote 212 hidden or not displayed.

### Example Operations

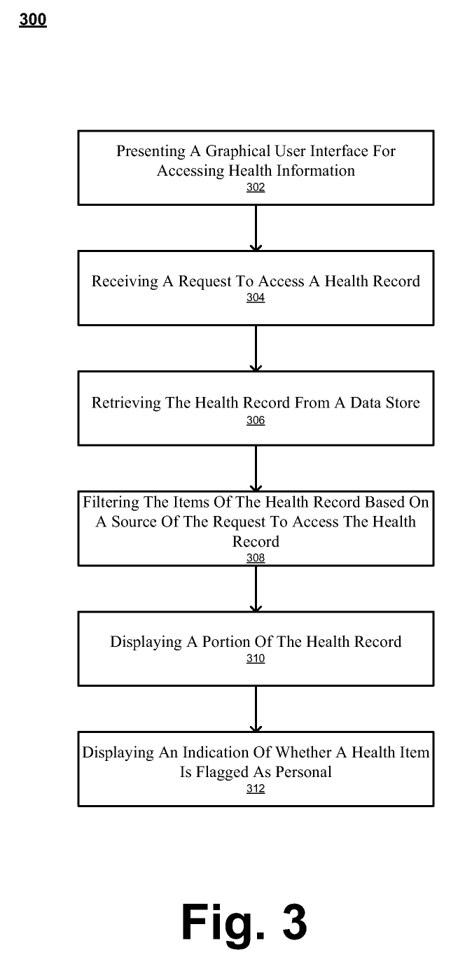

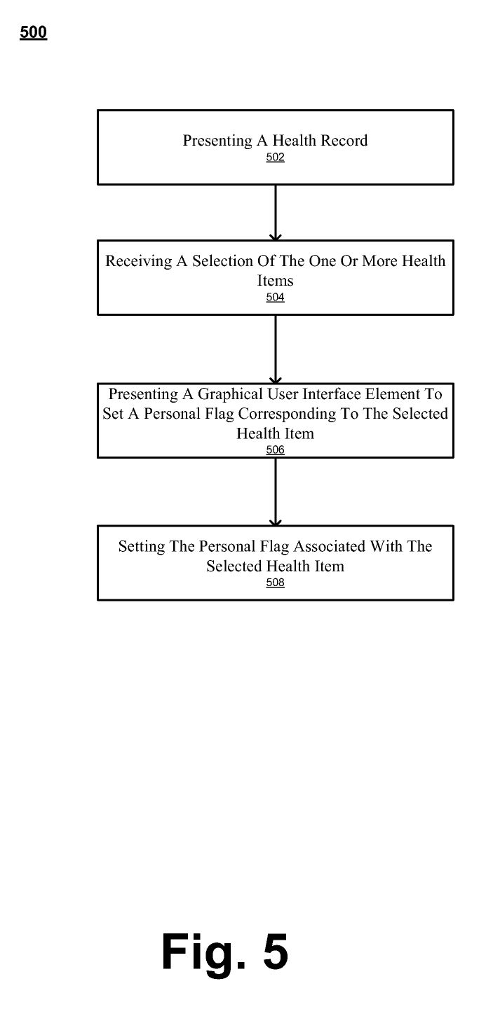

The following discussion sets forth in detail the operations of the present technology for accessing health information. With reference to FIGS. 3 and 5, flowcharts 300 and 500 each illustrate example blocks used by various embodiments of the present technology. Flowcharts 300 and 500 include processes that, in various embodiments, are carried out by a processor under the control of computer-readable and computer-executable instructions.

FIG. 3 is a flowchart 300 of an exemplary process for protecting access to health information, in accordance with an embodiment. The process of flowchart 300 may be carried out by a system (e.g., system 600) and be carried out in conjunction with a graphical user interface (e.g., graphical user interface 200).

At block 302, a graphical user interface is presented for accessing health information. The health information may include a health record which includes at least one item or file. For example, a health record for medications may include items corresponding to each medication a patient is currently taking.

At block 304, a request to access the health record is received. As described herein, the request may be made via a web browser to view a health record among a plurality of health records.

At block 306, a health record is retrieved from a data store (e.g., data store 102). As described herein, the data store may be a database, knowledge base, or the like.

At block 308, the items of the health record are filtered based on a source of the request to access the health record. In one embodiment, the source of the request may be a custodian, user with view and edit rights, or user with read only rights. Users with custodian privileges for a record are able to apply and remove the personal flag of instances of health record, health record items, and uploaded files. Thus, users with custodian privilege for a record will be able to view instances of health data and uploaded files that have been flagged as personal.

Users having view and edit rights are able to view non-personal data and add data but are not able to close records or change other aspects of health records. Users who do not have custodian privileges for a record will not be able to flag data as personal and will not be able to view data flagged as personal. That is, users who do not have custodian privileges for a record will not see the health record or health record items listed. Users having read only access are able to view non personal data and are not able to change any data.

In one embodiment the filtering is based on a personal information flag. A personal flag may be used to control access to a variety of health information including, but not limited to, health records, health record items, and uploaded files. The personal flag may be used to selectively control access to types of data (e.g., health records) and the instances of data (e.g., health record items or files). The personal flag could thus be used to allow a person to restrict viewing to conditions or certain conditions within the conditions category. For example, a patient may be taking several medications and may selectively hide some medications from relatives while a doctor is able to see all the medications.

The personal flag may be set by a variety of means including but not limited to a user, a computer, or based on a government law. In one embodiment, the personal flag may be set by a user who has custodian rights (e.g., patient or person with agent authority). The personal flag may also be set by a computer as part of a set of normal access rules or default rules may be part of the health information system which sets certain items as personal items. These rules may be set by a user, system administrator, or based on machine learning. For example, users may set specific rules or the health information system may learn when to set something as personal based on a users' personal flagging history.

The personal information flag may further be set based on a government law. For example, a government may mandate by law that mental health, religious affiliation, and sexual health be kept private (e.g., have the personal flag set) by default. The personal information flag may also be set by a health system management agent. A health system management agent may be operated by a health system administrator to comply with governmental law or other regulatory body and thereby implement changes as to which records or items may be set as personal by default.

At block 310, a portion of the health record is displayed. As described herein, the health record and the corresponding health record items with personal items may be filtered out.

At block 312, an indication of whether a health item is flagged as personal is displayed. For example, users with custodian privileges will see any data flagged as personal prefaced with an indication of the data being personal (e.g., text of “Personal” and personal flag indicator 206).

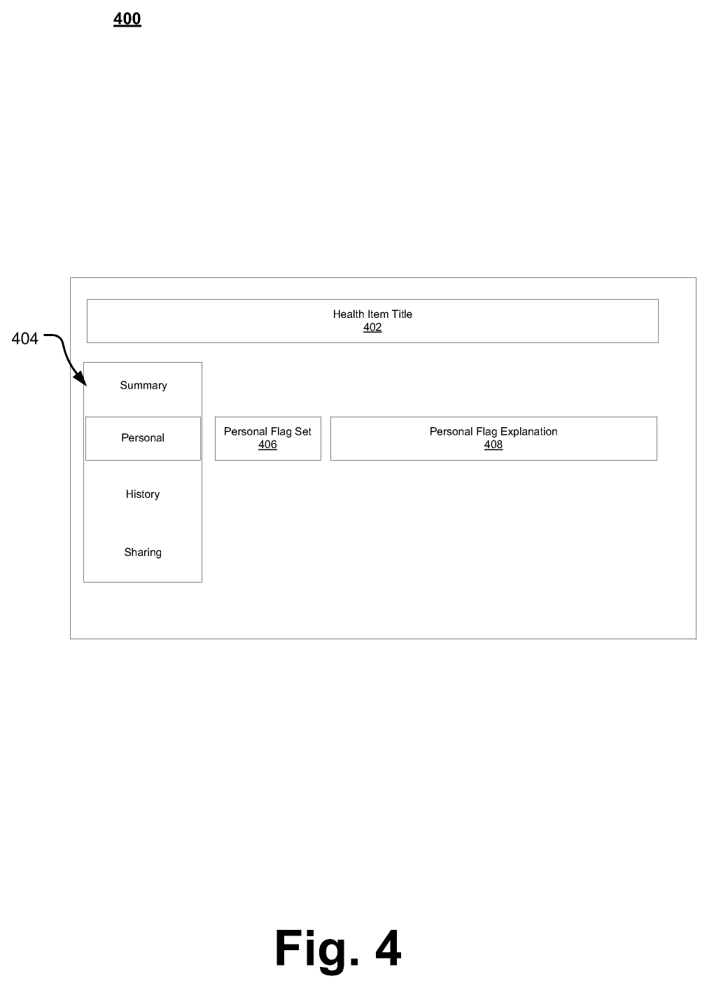

FIG. 4 is a block diagram of an exemplary graphical user interface 400 for setting access to health information in accordance with one embodiment. Exemplary graphical user interface 400 may be presented after a user has been successfully authenticated and has selected a health record or item (e.g., via graphical user interface 200). For example, exemplary graphical user interface may be accessed or presented via web browser after logging in. Exemplary graphical user interface 400 includes health item title 402, labels 404, personal flag set element 406, and personal flag explanation 408. In one embodiment, graphical user interface 400 is popup window displayed upon selection of health record, item, or file.

Health item title 402 displays that title of the health record, item, or file that was selected. For example, health item title 402 may indicate that a cardiac profile or an x-ray has been selected.

Labels 404 display the various areas and/or settings associated with the selected item or file. In one embodiment, labels 404 includes tabs for a summary section, personal settings, history of the selected item, and sharing settings for the item. In one embodiment, the personal tab can only be seen by a custodian of the record, item, or file. The personal tab may enable a user to apply the personal flag to a health record, health record item, or a file.

Personal flag set element 406 allows a user to set the personal flag for the associated health record, item, or file. For example, personal flag set element 406 may display the text “Designate this data as personal” which may be a link to set the personal flag. Personal flag explanation 408 may include an explanation of the current status of the personal flag associated with the health record, item, or file. For example, personal flag explanation 408 may include the text “Only custodians of a record can see data designated as personal. If you share this record with persons who are not custodians, they won't see personal data. Learn more”. The “learn more” text may be a link to a help section explaining the effect of designating or flagging data as personal.

If the user is viewing a health record, health record item, or file that is marked as personal, graphical user interface 400 may be customized accordingly. For example the text of Personal flag set element 406 may change to text including “Remove the Personal Designation from this data”. The text “Remove the personal designation from this data” may be a link which removes the personal flag from the selected item.

Correspondingly, personal flag explanation 408 may display text including “Only custodians of a record can see data designated as personal. If you remove this designation and share this record with persons who aren't custodians, they'll be able to see the data. Learn more.” The “learn more” text may be a hyperlink which directs a user to a help page explaining the personal flag.

It is appreciated the exemplary graphical user interface 400 may not display all fields and labels depending on whether a selected health record, item, or file is flagged as personal. For example, users without custodian access rights or privileges may not see the personal tab label in labels 404 and the corresponding personal flag set element 406, and personal flag explanation 408.

FIG. 5 is a flowchart 500 of an exemplary process for configuring access to health information, in accordance with an embodiment. The process of flowchart 500 may be carried out in conjunction with a graphical user interface (e.g., graphical user interface 400). The graphical user interface used in conjunction with flowchart 500 may be presented via a variety of applications including, but not limited to, web browser or a local executing application (e.g., desktop client software).

At block 502, a health record is presented. As described herein, the health record may include one or more health items. For example, the health record may relate to a ski accident and the one or more health items may reflect the medications and treatment corresponding to the ski accident. Health records may also include a category of health information (e.g., mental health, cardiac health, etc.).

At block 504, a selection of the one or more health items is received. For example, the user may have selected the medication associated with the ski accident.

At block 506, a graphical user interface element is presented to set a personal flag corresponding to the selected health item. The graphical user interface may be customized according to the current state of the health record item. For example, if the health record item is not personal the graphical user interface may allow a user to click the graphical user interface element to set the personal flag. Correspondingly, if the health record item is personal the graphical user interface may allow a user to click the graphical user interface element to remove the personal flag. The graphical user interface element may be hyperlink (e.g., personal flag set element 406) and may be displayed with explanatory text (e.g., personal flag explanation 408).

At block 508, the personal flag associated with the selected health item is set.

As described herein, the personal flag may be set or unset and used to protect or restrict access to health information.

### Example Operating Environments

With reference to FIG. 6, an exemplary system for implementing embodiments includes a general purpose computing system environment, such as computing system environment 600. Computing system environment 600 may include, but is not limited to, servers, desktop computers, laptops, tablet PCs, mobile devices, and smartphones. In its most basic configuration, computing system environment 600 typically includes at least one processing unit 602 and memory 604. Depending on the exact configuration and type of computing system environment, memory 604 may be volatile (such as RAM), non-volatile (such as ROM, flash memory, etc.) or some combination of the two. This most basic configuration is illustrated in FIG. 1 by dashed line 606.

System memory 604 may include, among other things, Operating System 618 (OS), application(s) 620, and health information application 622. Health information application 622 may facilitate access to various pieces of health information by doctors, nurses, patients, family members, friends, and the like. Health information application 622 may further include health record access module 624. Health record access module 624 facilitates protected access to health information. For example, health record access module 624 may provide access to certain health records, items or files that have been marked as personal by a user with custodian access privileges (e.g., the patient or those with agent authority) but not provide access to personal health information to others without custodian access privileges.

Additionally, computing system environment 600 may also have additional features/functionality. For example, computing system environment 600 may also include additional storage (removable and/or non-removable) including, but not limited to, magnetic or optical disks or tape. Such additional storage is illustrated in FIG. 6 by removable storage 608, non-removable storage 610, and data storage service 626. Data storage service 626 may provide storage for service applications and be in a variety of storage configurations including but not limited to, remote and distributed storage. Computer storage media includes volatile and nonvolatile, removable and non-removable media implemented in any method or technology for storage of information such as computer readable instructions, data structures, program modules or other data. Memory 604, removable storage 608, nonremovable storage 610, and data storage 626 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 600. Any such computer storage media may be part of computing system environment 600.

Computing system environment 600 may also contain communications connection(s) 612 that allow it to communicate with other devices. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 612 may allow computing system environment 600 to communication over various networks types including, but not limited to, Bluetooth, Ethernet, Wi-Fi, Infrared Data Association (IrDA), Local area networks (LAN), Wireless Local area networks (WLAN), wide area networks (WAN) such as the internet serial, and universal serial bus (USB). It is appreciated the various network types that communication connection(s) 612 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 600 may also have input device(s) 614 such as a keyboard, mouse, pen, voice input device, touch input device, remote control, etc. Output device(s) 616 such as a display, speakers, etc. may also be included. All these devices are well known in the art and need not be discussed at length here.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for protecting access to health information comprising:
presenting a graphical user interface for accessing health information, wherein said health information comprises a health record comprising at least one item;
receiving a request to access said health record;
retrieving said health record from a data store;
filtering said items of said health record based on a source of said request to access said health record; and
displaying a portion of said health record.

2. The method as recited in claim 1 further comprising:
displaying an indication of whether a health item is flagged as personal.

3. The method as recited in claim 1 wherein said source of said request to access said health record is a custodian.

4. The method as recited in claim 1 wherein said source of said request to access said health record is a user having view and edit rights.

5. The method as recited in claim 1 wherein said source of said request to access said health record is a user having read only access.

6. The method as recited in claim 1 wherein said filtering is based on a personal information flag.

7. The method as recited in claim 6 wherein said personal information flag is set by a user.

8. The method as recited in claim 6 wherein said personal information flag is set by a computer.

9. The method as recited in claim 6 wherein said personal information flag is set based on a government law.

10. The method as recited in claim 6 wherein said personal information flag is set by a health system management agent.

11. An apparatus for accessing health information comprising:
a data store for storing health information, wherein said health information comprises one or more health records each comprising one or more items;
a data store access module for retrieving health information from said data store;
a graphical user interface module facilitating display of health information stored within said data store; and
a personal flag module for setting a personal flag associated with each item within each health record in said data store.

12. The apparatus as recited in claim 11 wherein said data store is a database.

13. The apparatus as recited in claim 12 wherein said item is a row in a database.

14. The apparatus as recited in claim 11 wherein said personal flag restricts access to an item within said health record.

15. The apparatus as recited in claim 11 wherein said personal flag optionally overrides future access rule changes.

16. The apparatus as recited in claim 11 wherein said personal flag overrides access rules.

17. The apparatus as recited in claim 11 wherein said data store access module returns a portion of said health record.

18. A method for configuring access to health information comprising:
presenting a health record, wherein said health record comprises one or more health items;
receiving a selection of said one or more health items;
presenting a graphical user interface element to set a personal flag corresponding to said selected health item; and
setting said personal flag associated with said selected health item.

19. The method of claim 18 wherein said health record comprises a category of health information.

20. The method of claim 18 wherein said graphical user interface element comprises a hyperlink.
